(19) United States
(12) Patent Application Publication
(10) Pub. No.: US 2012/0125212 A1
(43) Pub. Date: May 24, 2012

(54) VARIABLE IDENTIFICATION STAMP

(75) Inventor: Wolfgang Opitz, Aschaffenburg (DE)

(73) Assignee: OPITZ GMBH, Aschaffenburg (DE)

(21) Appl. No.: 13/380,396

(22) PCT Filed: Apr. 30, 2010
(86) PCT No.: PCT/EP2010/055888

§ 371 Date: Feb. 14, 2012

(30) Foreign Application Priority Data
Jun. 23, 2009 (DE) 10 2009 027 108.2

(51) Int. Cl. B41K 1/42

(52) U.S. Cl. 101/333

(57) ABSTRACT

An identification stamp comprises a housing (1, 2) having a transferrable marking (11) at the housing end face and an adjustment element (3) which is inserted in the housing (1, 2) in an adjustable manner and which is provided with a transferrable marking (31) at its end face. When the adjustment element (3) is adjusted with respect to the housing (1, 2), the marking (11) is adjusted relative to the marking (31). An engagement means (33, 13) is made of at least one detent nose (33), which is integrally arranged on the adjustment element (3) in the axial direction in a protruding manner and which engages with one of a plurality of locking grooves (13) integrally arranged on the housing (1) in the axial direction in a recessed manner.

This application is entitled to the benefit of, and incorporates by reference essential subject matter disclosed in PCT Application No. PCT/EP2010/055888 filed on Apr. 30, 2010, which claims priority to German Application No. 10 2009 027 108.2 filed Jun. 23, 2009.

### BACKGROUND OF THE INVENTION

1. Technical Field

The present invention relates to an identification stamp for insertion into a forming or embossing tool for metal or plastic marking.

2. Background Information

Different surfaces of molded products often show different markings, such as manufacturing date, batch number, product number, etc., adapted to be used for different purposes, e.g. for checking the material properties of specific batches or for supporting the stock-keeping organization.

Generally, these markings are stamped into the product to be marked by an embossing device. The embossing device comprises an identification stamp provided, at its end face, with the respective markings adapted to be applied onto the molded product.

Usually, such an identification stamp is composed of an (often cylindrical) base body (housing) having a transferrable marking on its end face, which is fixed to the embossing tool, and of an adjustable marking or embossing body (adjustment body), which is seated in the base body and is provided with further information to be imprinted on its end face. The end faces of the base body and the adjustable marking body are aligned with each other and face the product (metal or plastics) to be provided with the stamping. Thus, an outer marking area is provided on the end face of the base body, and an inner marking area on the end face of the adjustable marking body.

By the German utility model DE 93 14 975 U1, an identification stamp is disclosed. In a cylindrical housing body, this identification stamp comprises one or several adjustment bodies whose end faces are aligned with the end face of the housing body. The adjustment bodies can be removed from the housing body in the direction opposite to the end face.

A further identification stamp is disclosed by the document DE 197 30 772 A1. In a cylindrical housing body, this identification stamp comprises an adjustment body which is biased by a spring such that its end face is aligned with the end face of the housing body. When this is done, the spring acts on an insertion groove in the adjustment body in the axial direction.

Documents JP 61 045112 U, DE 199 28 044 A1 and DE 297 17 308 U each disclose an identification stamp having an adjustment body adjustable on the housing. The adjustment body as well as the housing comprises a plurality of detent noses and engagement grooves assigned to the detent noses.

Documents JP 60 088714 U, JP 10 264161 A and JP 10 0444163 A each disclose an identification stamp having an adjustment body adjustable on the housing. These documents do not teach any detent noses, but elastically preloadable detent balls.

Thus, it is an object of the invention to provide an identification stamp having minimized installation dimensions and a minimum number of components, so that it can be produced economically. Moreover, the locking function is to be designed in an advantageous manner.

### SUMMARY OF THE DISCLOSURE

Said object is achieved by an identification stamp comprising the features of the enclosed claim 1 or 2.

Advantageous further developments form the subject-matters of the further claims.

In the case of the identification stamp of the present invention, the locking procedure between the adjustment element and the housing body is configured such that the tool pressure (embossing pressure, internal mold pressure) can be used for intensifying the locking force so as to integrate, with minimal locking depths, the largest possible number of locking positions in the smallest possible stamp dimensions, so that a smallest possible number of adjustable inserts (adjustment elements) can be used for the largest possible number of base bodies (housings).

The identification stamp according to the invention is composed of a (cylindrical) base body (housing), which has a transferrable marking and which can be mounted on the embossing tool, and an adjustable insert (adjustment element), which is formed as a bolt and has at least one marking formed as an indicator arrow, and a recess suited for receiving a rotary tool. Said adjustable insert rotatably abuts with its lower head side on a contact surface in the base body and is detachably connected by its threaded shaft set off inwardly at the lower head side with a spring-biased holding part in the form of a threaded spindle inside the base body. Furthermore, the identification stamp has a locking function between the adjustable insert (adjustment element) and the base body (housing).

The contact surface on the adjustable insert is provided with one raised detent nose and the contact surface on the base body is provided with several recessed locking grooves, these being integrally molded with the adjustable insert and the base body, respectively, and engaging with each other in an axial tool pressure direction.

For solving the problem according to the invention, i.e. to create an identification stamp having minimized installation dimensions, the locking means is arranged such that the locking direction is axial, i.e. in the tool pressure direction and in direct interaction with said tool pressure (embossing pressure, internal mold pressure), i.e. the locking force is intensified in response to the tool pressure. The locking force, which is defined by a compression spring, can be adjusted to the necessary torque for the operation of a rotary tool to be operated manually in connection with a locking profile suited for releasing the locking connection. One detent nose is integrally molded on the lower contact surface of the adjustable insert and several locking grooves are integrally molded on the corresponding contact surface of the base body. This construction makes it possible to realize small locking depths, small locking distances and, thus, small structural dimensions.

The base body is fixed in the tool and has radially arranged markings, which are different but unchangeable, at the upper annular surface (for months, weeks, days, etc.).

The inner rotatable adjustable insert is exchangeable from the inner side of the tool and has an indicator arrow on its end face, said arrow also being used for receiving a screwing tool and being adjustable to point to the markings on the outer base body, as well as, alternatively, additional modifiable markings, which can be exchanged at certain times (year, index, etc.).

In order to realize a minimized number of changeable (exchangeable) adjustable inserts for all kinds of base bodies having a different number of markings to be adjusted, the arrangement of the locking means between the base body and the adjustable insert is designed such that one detent nose is mounted on the adjustable insert in position to its indicator arrow and, on the base body, a locking groove is assigned to every marking (12 months=12 locking grooves; 31 days=31 locking grooves, etc.).

Thus, contrary to the state of the art of documents DE 93 14 975 U1 and DE 197 30 772 A1 described at the outset, the working pressure acts in the locking direction and the detent nose and the locking groove (without any components additionally to be mounted) are integrally formed on the housing body and the adjustable insert body, respectively. Thus, the identification stamp of the present invention guarantees a miniaturization of this type of identification stamps. Thereby, it can be manufactured in a very economical way.

### BRIEF DESCRIPTION OF THE DRAWINGS

FIG. 1 shows a view of the longitudinal section of an identification stamp according to the invention.

FIG. 2 shows a top view B of the identification stamp according to the invention of FIG. 1, the adjustment element being inserted.

FIG. 3 shows a top view B of the identification stamp of FIG. 1, the adjustment element being removed. Contrary to the actual display of the symbols, the symbols of the embossing surfaces in FIGS. 2 and 3 are not shown in an inverted manner so as to enhance clarity.

FIG. 4 shows a sectional view A-A of FIG. 1.

### DETAILED DESCRIPTION OF THE INVENTION

In the following, the embodiments of the present invention are described.

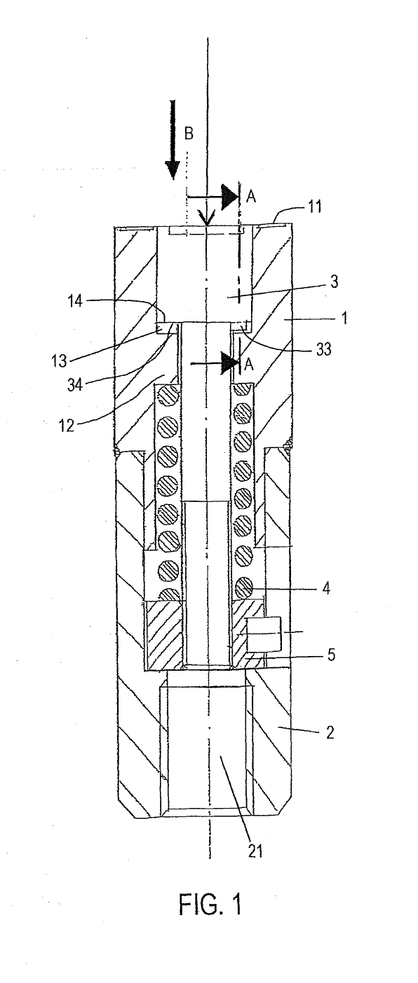

FIG. 1 shows a view in the longitudinal section of an identification stamp according to the invention.

In the description of the present invention, the upper side of the identification stamp is defined as the side comprising the marking which is to be applied onto the workpiece to be marked. The lower side of the identification stamp is defined as the side that faces away from the marking side and is used for mounting on an embossing tool. Therefore, in FIG. 1, the marking side is at the top.

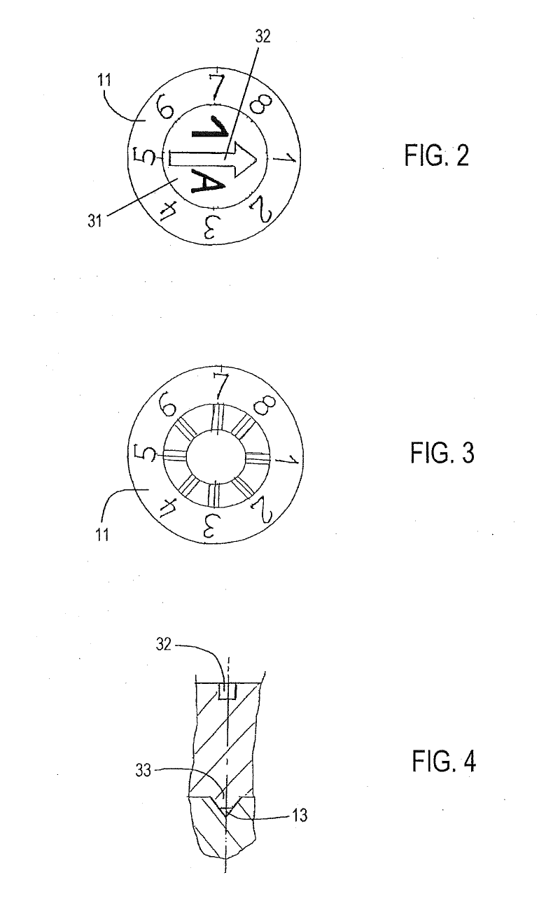

The identification stamp according to the invention is composed of an upper part 1 of the housing body (hereinafter: housing body upper part 1) and a lower part 2 of the housing body (hereinafter: housing body lower part 2). The upper side (upper surface) of the housing body upper part 1 forms the embossing side (marking side). The housing body upper part is formed as a cylinder and is provided with a through hole. The upper surface (end face) of the cylinder (of the cylinder wall) is provided with a marking area 11 which, in the operation of the identification stamp, faces the product to be processed, which is to be marked (plastics, metal, etc.). In the present embodiment, the marking area 11 is provided with the numerals from 1 to 8, as this is shown in FIG. 2 and FIG. 3. Thus, the marking area 11 is located at the end face or upper end face of the base body upper part 1.

The through hole in the housing body upper part 1 is provided with a projection on the housing (housing projection) 12 projecting towards the imaginary central axis of the housing body upper part 1 at the whole inner circumferential surface of the through hole.

In the present embodiment, the housing projection 12 is elaborated as a flange which is rectangular in the longitudinal section (of FIG. 1) and which is located slightly above the center in the axial direction of the base body upper part 1. The surface of the housing projection 12 pointing upwards forms a contact surface 14.

The downwardly directed surface of said housing projection 12 also forms a contact surface (without reference signs).

In the lower area of the base body upper part 1, a step of a suitable length is elaborated to allow assembling with a housing body lower part 2. Therefore, in the present embodiment, a connecting area is provided on the outer circumference of the housing body lower part 1 such that the lower end area has a smaller outer diameter than the upper area of the housing body upper part 1. In said area having a smaller outer diameter of the housing body upper part 1, a thread for establishing a connection with the housing body lower part 2 is elaborated.

The housing body lower part 2 is also formed as an elongate cylinder provided with a through hole. At the lower side of the housing body lower part 2, the through hole is enlarged into a screw-in hole 21 which is provided with an internal thread and is used for being screwed into a respective embossing tool or marking tool. Slightly above the threaded area of the screw-in hole 21, the inner diameter of the through hole is enlarged and has a dimension adapted for receiving the lower section of the housing body upper part 1. Therefore, the upper section of the inner circumferential side of the through hole in the housing body lower part 2 is provided with an internal thread which is in a threaded engagement with the outer thread of the lower section of the housing body upper part 1. Thus, the upper section of the housing body lower part 2 and the lower section of the housing body upper part 1 overlap in the radial direction.

The identification stamp of the present invention further has a rotatable adjustment element 3, a spring element 4 and a spring stroke adjusting element 5. When screwed together, the housing body upper part 1 and the housing body lower part 2 form a spring chamber along the through hole between the lower contact surface of the housing projection 12 and the step in the housing body lower part 2, which also serves as contact surface, located above the screw-in hole 21 and forming the diameter extension in the through hole of the housing body lower part 2. The spring element 4 and the spring stroke adjusting element 5 are accommodated in this spring chamber in the manner shown in FIG. 1.

Therein, the spring stroke adjusting element 5, which is formed as a nut having a central through hole, is accommodated in the lower section adjacent to the contact surface located above the screw-in hole 21. An internal thread is elaborated in said central through hole. The spring element 4 is accommodated in a suitably biased state between the upper surface of the spring stroke adjusting element 5 and the lower contact surface of the housing projection 12.

The adjustment element 3 is a cylindrical body having a head at its upper side and an elongate cylindrical section having a smaller outer diameter than on the head at the bottom side. The head has an outer diameter which is dimensioned such that it can be inserted into the upper section of the housing body upper part 1 from the top, wherein the inner circumferential surface of the upper section of the housing body upper part 1 serves as guiding surface for the outer surface of the head of the adjustment element 3. Thus, the head of the adjustment element 3 can be inserted into the upper area of the housing body upper part up to the upper contact surface 14 of the housing projection 12. At the upper surface or end face, the head of the adjustment element 3 is provided with a marking area 31, as shown in FIG. 2, having an adjustment groove 32 into which an adjusting tool (e.g. an adjusting tool in the form of a screw driver) can be inserted. The adjustment groove 32 is elaborated as an arrow pointing to one of the numerals of the marking area 11 of the housing body upper part 1, i.e. in the present embodiment to one of numerals 1 to 8. Moreover, if required, the marking area 31 may comprise further symbols, as is shown in FIG. 2.

The diameter of the lower elongate cylinder piece of the adjustment element 3 is smaller than the outer diameter of the head. Thus, a step is formed at the connecting point between the elongate cylinder piece and the head.

At this step, the lower surface of the head of the adjustment element 3 forms a contact surface 34 which is in abutment with the contact surface 14 of the housing body upper part 1. The adjustment element 3 is rotatable relative to the housing body, this rotational movement being effected by an adjusting tool inserted into the adjustment groove 32 of the adjustment element 3. The elongate cylinder provided on the head of the adjustment element 3 and forming an elongation pointing downwards has an outer diameter which is smaller than the inner circumferential surface of the housing projection 12 and the spring element 4. The lower section of said cylinder is provided with a thread being in threaded engagement with the inner thread of the spring stroke adjusting element 5. The spring stroke adjusting element 5 can be screwed along said elongate cylinder of the adjustment element 3 in order to adjust the spring stroke of the spring element 4 and, thus, the biasing thereof.

The adjustment element 3 can, thus, be inserted into the through hole of the housing body upper part 1 and the housing body lower part 2 at the top (marking side) until the contact surfaces 14 and 34 abut against each other. In this way, the operating state is reached. In this operating state, the marking areas 11 and 31 forming the marking surfaces are substantially aligned with each other.

The contact surfaces 14 and 34 are not completely flat. The head of the adjustment element has a detent nose 33 which is formed as a projection protruding downwards, i.e. in the axial direction, at its lower contact surface 34 in the area which is in abutment with the upper contact surface 14 of the projection 12. In the present embodiment, the detent nose 33 is formed in a V-shape having a flattened end, as this is shown in FIG. 1 and in the sectional view A-A in FIG. 4. The contact surface 14 on the housing projection 12 is provided with a plurality of locking grooves 13 which are recessed in the axial direction of the identification stamp and in which the detent nose 33 can lock in place. In the present embodiment, eight locking grooves 13 are provided on the contact surface 14 at equal distances, said locking grooves corresponding to the adjustment possibilities represented by the eight numerals in the marking area 11. Each locking groove 13 is elaborated such that the detent nose 33 engages such that the contact surfaces 14 and 34 abut against each other flatly. Therefore, in the present embodiment, the locking groove 13 is formed as a V-shaped recess, as this is clearly shown in FIG. 4.

Ideally, the detent nose 33 and the locking grooves 13 extend in a radial direction. The locking grooves 13 are preferably shaped such that they reach up to the inner circumference of the upper region of the housing body upper part 1. The detent nose 33 is preferably shaped such that it leaves an inteimmediate space to the inner circumference of the upper area of the housing body upper part 1, as this is shown in FIG. 1.

### ADVANTAGES OF THE EMBODIMENT

For realizing the locking function, the identification stamp described in the above embodiment comprises the housing element 1 and the adjustment element 3 on which the detent nose 33 and the locking grooves 13 are integrally arranged, respectively. Thus, the identification stamp comprises a minimum number of components.

This construction makes it possible to realize small locking depths, small locking distances and, thus, small constructional dimensions.

As, in operation, the embossing pressure on the adjustment element 3 acts in the same direction in which the detent nose 33 is pressed into the locking groove 13, the identification stamp according to the invention is very safe to operate.

### Further Embodiments

A further embodiment describes the alternative of the detent nose not being provided on the adjustment element, but on the housing projection. Accordingly, the locking grooves are not provided on the housing projection, but on the adjustment element. This leads to a similar advantageous embodiment, which achieves similar effects.

In the afore-described embodiment, the marking area 11 is provided with numerals from 1 to 8 and, therefore, eight locking grooves 13 are provided accordingly. According to a further embodiment, numerals 1 to 12 and twelve locking grooves can be provided instead in the marking area, so that a locking adjustment with regard to the months is achieved. In a further embodiment, numerals 1 to 31 and thirty-one locking grooves can be provided in the marking area, allowing the setting of a day. Basically, any selection of numerals provided in the marking area is conceivable with the corresponding number of locking grooves. Moreover, also other symbols apart from numerals are embossable in the respective marking area. In this case, too, the marking area 11 comprises symbols the number of which corresponds to the number of locking grooves 13.

According to the afore-described embodiment, the detent nose 33 is formed into a V-shape having a flattened end, as this is shown in FIG. 4. According to a further embodiment, the detent nose can be made to have a rounded-off end, whereby the wear on the contact surface 14 of the projection 12 can be reduced.

According to a further embodiment, the shape of locking groove and detent nose can be modified. For example, the V-shape of the locking groove can be combined with a semi-cylindrical shape of the detent nose, or locking groove as well as detent nose can be semi-cylinders. In this case, too, the wear of the contact surface 14 can be reduced. Also further shapes are conceivable, provided that the locking function is realized in a sufficiently safe manner.

According to a further non-claimed example, not one detent nose, but several detent noses can be provided on the adjustment element. According to the non-claimed example, two detent noses can be formed so as to be diagonally opposite on the lower side of the adjustment element. In this way, the force distribution is optimized during the adjusting procedure (locking adjustment), and e.g. a slanted position of the adjustment element is avoided. According to a further non-claimed example, the provision of several detent noses is also applicable with the alternative, according to which the detent nose is not provided on the adjustment element, but on the housing projection.

Although this invention has been shown and described with respect to the detailed embodiments thereof, it will be understood by those skilled in the art that various changes in form and detail thereof may be made without departing from the spirit and the scope of the invention.

What is claimed is:

1. An identification stamp comprising:
a housing having a transferrable marking at the housing end face, the housing being composed of a housing upper part and a housing lower part;
an adjustment element which is inserted in the housing in an adjustable manner and which is provided with a transferrable marking at its end face, wherein, when the adjustment element is adjusted with respect to the housing, the marking is adjusted relative to the marking;
a projection being provided on the inner circumference of the housing, wherein the adjustment element inserted in the housing abuts on the surface of the projection facing upwards; and
a spring element under preload abuts on the surface of the projection facing downwards;
characterized by
an engagement means made of one detent nose, which is integrally arranged on the adjustment element on the side opposite to the end face in the axial direction in a protruding manner and engages with one of a plurality of locking grooves integrally arranged on the housing in the axial direction in a recessed manner;
wherein the engagement means is formed on the projection and on a contact surface of the adjustment element abutting on the projection.

2. An identification stamp comprising
a housing having a transferrable marking at the housing end face, the housing being composed of a housing upper part and a housing lower part; and
an adjustment element which is inserted in the housing in an adjustable manner and which is provided with a transferrable marking at the end face, wherein, when the adjustment element is adjusted with respect to the housing, the marking is adjusted relative to the marking;
a projection being provided on the inner circumference of the housing, wherein the adjustment element inserted in the housing abuts on the surface of the projection facing upwards; and
a spring element under preload abuts on the surface of the projection facing downwards,
characterized by
an engagement means made of one detent nose, which is integrally arranged on the housing upper part in the axial direction in a protruding manner and which engages with one of a plurality of locking grooves integrally arranged on the adjustment element on the side opposite to the end face in the axial direction in a recessed manner,
wherein the engagement means is formed on the projection and on a contact surface of the adjustment element abutting on the projection.

3. (canceled)

4. The identification stamp according to claim 1, wherein
the marking on the housing end face comprises symbols, the number of which corresponds to the number of locking grooves, and
the marking comprises at least one indicator arrow.

5. The identification stamp according to claim 1, wherein the one detent nose and the engagement grooves extend in a radial direction.

6. The identification stamp according to claim 1, wherein
the engagement grooves extend to the inner circumference of the housing upper part; and
a gap is left between the detent nose and the inner periphery of the upper region of the housing upper part.

7. (canceled)

8. The identification stamp according to claim 4, wherein
in the transferrable marking at the end face, the adjustment element comprises the indicator arrow as recess for receiving an adjustment tool.

9. The identification stamp according to claim 2, wherein
the marking on the housing end face comprises symbols, the number of which corresponds to the number of locking grooves; and
the marking comprises at least one indicator arrow.

10. The identification stamp according to claim 2, wherein the one detent nose and the engagement grooves extend in a radial direction.

11. The identification stamp according to claim 4, wherein the one detent nose and the engagement grooves extend in a radial direction.

12. The identification stamp according to claim 2, wherein
the engagement grooves extend to the inner circumference of the housing upper part; and
a gap is left between the detent nose and the inner periphery of the upper region of the housing upper part.

13. The identification stamp according to claim 4, wherein
the engagement grooves extend to the inner circumference of the housing upper part; and
a gap is left between the detent nose and the inner periphery of the upper region of the housing upper part.

14. The identification stamp according to claim 5, wherein
the engagement grooves extend to the inner circumference of the housing upper part; and
a gap is left between the detent nose and the inner periphery of the upper region of the housing upper part.

15. The identification stamp according to claim 5, wherein in the transferrable marking at the end face, the adjustment element comprises the indicator arrow as recess for receiving an adjustment tool.

16. The identification stamp according to claim 6, wherein in the transferrable marking at the end face, the adjustment element comprises the indicator arrow as recess for receiving an adjustment tool.

17. The identification stamp according to claim 7, wherein in the transferrable marking at the end face, the adjustment element comprises the indicator arrow as recess for receiving an adjustment tool.
